(19) United States
(12) Patent Application Publication
(10) Pub. No.: US 2016/0107392 A1
(43) Pub. Date: Apr. 21, 2016

(54) THREE-DIMENSIONAL (3-D) DIGITAL FINISHING ARCHITECTURE

(71) Applicant: XEROX Corporation, Norwalk, CT (US)

(72) Inventors: DARA NANETTE LUBIN, PITTSFORD, NY (US); KEVIN JOSEPH ST.MARTIN, ROCHESTER, NY (US); CAROL-LYNN VIDJAN, ROCHESTER, NY (US)

(21) Appl. No.: 14/519,680

(22) Filed: Oct. 21, 2014

(51) Int. Cl. B29C 67/00; G06F 17/50; G05B 15/02

(52) U.S. Cl. CPC B29C 67/0088; G05B 15/02; G06F 17/50; B33Y 50/02

(57) ABSTRACT

Systems and methods include/use, among other components, a three-dimensional (3-D) printer creating 3-D items based on 3-D printing information, and a finishing device. The finishing device performs finishing operations on the 3-D item based on finishing information. Also, such systems and methods include a communications device, and the communications device automatically provides the 3-D printing information to the 3-D printer, provides the finishing information to the finishing device, and provides two-way status information updates between the 3-D printer and the finishing device.

### BACKGROUND

Systems and methods herein generally relate to three-dimensional printing and finishing, and to communication systems.

Conventional three-dimensional (3-D) printing is characterized as “additive” manufacturing, which means that a solid, three-dimensional object is constructed by adding material in layers. This is in contrast to “subtractive” manufacturing, through which an object is constructed by cutting (or “machining”) raw material into a desired shape. 3-D printer processes vary, but the material is usually sprayed, squeezed, or otherwise transferred from the printer onto a platform.

The first stage of 3-D printing is laying out an object's design with software, such as computer-aided design (CAD) or animation modeling software. Such software allows one to create a virtual blueprint of the object one wants to print. The software then automatically divides the designed object into digital cross-sections, which the printer builds layer by layer. The cross-sections essentially act as guides for the printer, so that the object is the exact size and shape designed.

After the finished design file is sent to the 3-D printer, one chooses a specific material. Different print heads can add different materials to the object being created (e.g. rubber, plastics, paper, polyurethane-like materials, metals, and more). Then, the 3-D printer makes passes (much like an inkjet printer) over the platform, depositing layer on top of layer of material to create the finished product.

Presently three-dimensional printed objects are typically finished, coated or painted in a completely offline, manually initiated process that is not in communication with the printer.

### SUMMARY

Exemplary systems herein include, among other components a three-dimensional (3-D) printer creating 3-D items based on 3-D printing information, and a 3-D finishing device operatively (meaning directly or indirectly) connected to the 3-D printer. The finishing device performs finishing operations on the 3-D item based on finishing information.

Also, such systems include a communications device that is operatively connected to the 3-D printer and the finishing device. The communications device can comprise one or more devices, such as stand-alone computers, print servers, or custom circuit boards with special-purpose circuitry (such as application specific integrated circuits (ASIC) devices); and such device(s) can be separate devices, or can be integral with the 3-D printer and/or the 3-D finisher device. The communications device automatically provides the 3-D printing information to the 3-D printer, provides the finishing information to the 3-D finishing device, and provides two-way status information updates between the 3-D printer and the 3-D finishing device.

For example, the finishing information can comprise command signals and status signals. The status signals can be status information of the process of creating the 3-D item. The command signals can be instructions of finishing operations to be performed on the 3-D item.

In detail, the communications device transmits the finishing information from the 3-D printer to the 3-D finishing device at any time after the printing/finishing instructions are created, such as during the time period between when the 3-D printer begins creating the 3-D item and when the 3-D printer completes creating the 3-D item. In some limited examples, the finishing information can include the dimensions of the 3-D item, instructions to begin cycle-up processes of one or more finishing devices, requests for progress status of finishing operations, requests for ready state, consumable supply levels, and failure status states of the one or more finishing devices, etc.

In various methods herein the 3-D printer (or the special-purpose communications device) receives the 3-D printing information. The 3-D printer automatically creates the 3-D item based on the 3-D printing information. These methods also automatically provide finishing information to a 3-D finishing device using the special-purpose communications device. The 3-D finishing device automatically performs finishing operations on the 3-D item based on the finishing information, and, again, the communications device is operatively connected to the 3-D printer and the 3-D finishing device. Further, such methods automatically provide two-way status information updates between the 3-D printer and the 3-D finishing device using the special-purpose communications device.

Again, the finishing information comprises command signals and status signals, the status signals comprise status information of the progress of the creating the 3-D item, the command signals comprise instructions of finishing operations to be performed on the 3-D item, etc. The process of transmitting the finishing information transmits the finishing information from the 3-D printer to the 3-D finishing device at any time after the printing/finishing instructions are created, such as during the time period between when the 3-D printer begins creating the 3-D item and when the 3-D printer completes creating the 3-D item.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a schematic diagram illustrating systems herein;

FIG. 2 is a schematic diagram illustrating devices herein;

FIG. 3 is a schematic diagram illustrating devices herein;

FIG. 4 is a schematic diagram illustrating devices herein;

FIG. 5 is a schematic diagram illustrating systems herein;

FIGS. 6A and 6B are command and signal tables used by systems and methods herein; and

FIG. 7 is a flow diagram of various methods herein.

### DETAILED DESCRIPTION

As mentioned above, three-dimensional printed objects are typically finished, coated, painted, etc., in a completely offline, manually initiated process that is not initiated by, or based on, any form of communication with the printer. Therefore, the systems and methods herein provide a 3-D digital finishing architecture (communication system) that uses information from the printer to set up a downstream finishing device, to allow the downstream finishing device to be ready to accept a 3-D printed piece and perform the appropriate function or functions to finish the workpiece accurately, in a timely manner, and without unnecessary wait time or finisher idle time (which could consume excess power needlessly).

The system of communication herein provides job parameters, such as the size of the workpiece, weight of the workpiece, as well as information about the desired finishing needed for the workpiece. The communication uses any industry standard communication protocol, such as but not limited to, universal serial bus (USB), Internet, controller area network bus (CANbus), etc. One benefit of using industry standard communication protocols is that it allows “plug and play” capabilities, so that the 3-D printer can understand what finishing capabilities are available. Systems herein allow finisher profile information (e.g., boundary conditions of each specific finishing device) with finishing constraints and timing requirements.

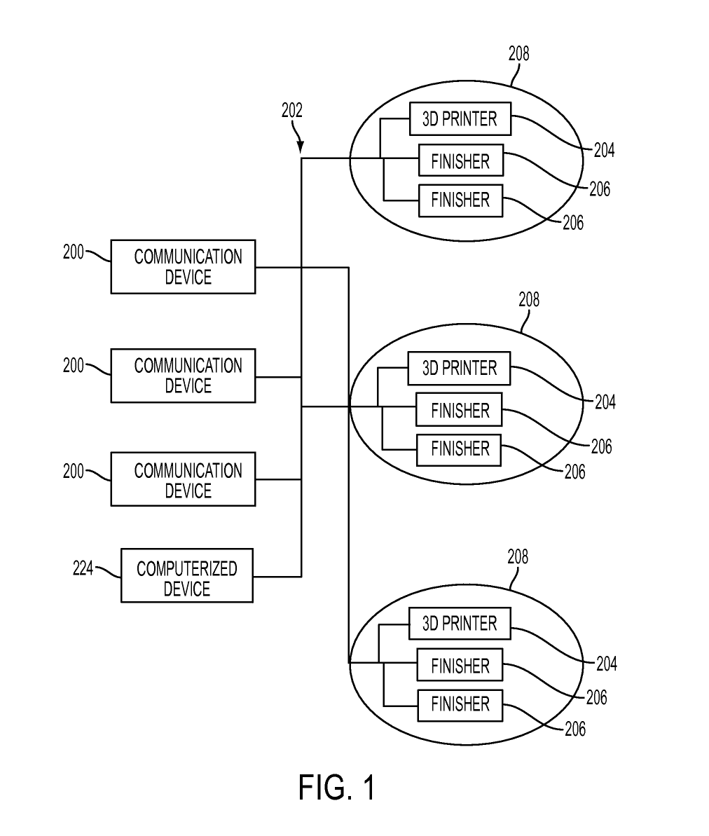

As shown in FIG. 1, exemplary systems and methods herein include various computerized devices, such as special purpose communication devices 200, 3-D printers 204, 3-D finishing equipment 206, etc., located at various different physical locations 208. The various devices 200, 204, 206 are in communication (operatively connected to one another) by way of a local or wide area (wired or wireless) network 202. Item 224 represents one or more general-purpose computerized devices that can be used to create and provide 3-D data (printing and finishing data) using, for example, a computer-aided design (CAD) program. When using the CAD program on the general-purpose device, the user can select various finishing options. Thus, the general-purpose device can output a “job” that contains instructions or printing and finishing the 3-D printed item. Such a job is supplied to the 3-D printers 204 and the 3-D finishing devices 206) using the communications devices 200.

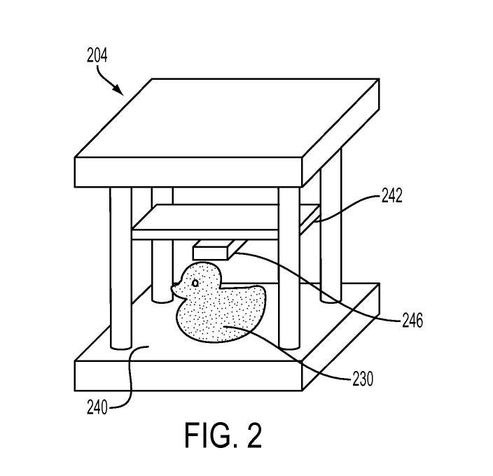

FIG. 2 illustrates one example of a 3-D printer 204 that includes a base 240, a carrier 242, and a printhead 246 supported by the carrier 242. The carrier 242 allows the printhead 246 to move above various locations of the base 240 and deposit multiple layers of material (e.g. rubber, plastics, paper, polyurethane-like materials, metals, and more). Specifically, a previously designed 3-D object is divided into digital cross-sections, which the printhead 246 builds layer by layer on the base 242 create a 3-D item 230.

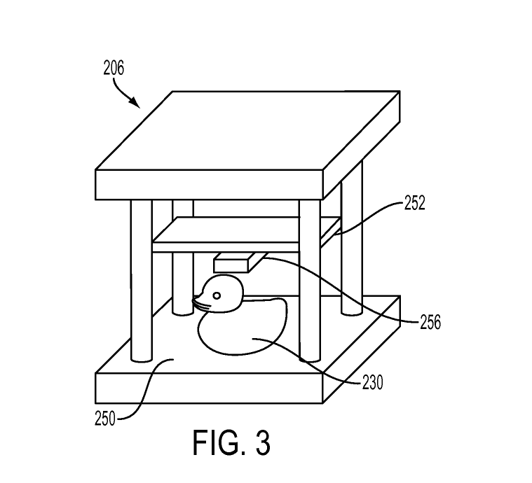

FIG. 3 illustrates one example of a 3-D finisher 206 that similarly includes a base 250, a carrier 252, and any form of finisher device 256, such as a painting device, smoothing device (e.g., vapor bath device), shaping device (using grinding/sanding equipment), etc. For example, many finishing devices use heat and/or solvent gases that smooth the different plastics used in the 3-D printing processes to eliminate the appearance of the distinct printed layers of the 3-D items. Also, finishing devices can paint, print, or otherwise color the outer surface of the 3-D items, or can apply pressurized air and/or contact abrasives to the surface of the 3-D items (e.g., through particle (e.g., sand, pellet, etc.) blasting, sanding, grinding, etc.) to provide shaping and texture to the 3-D printed item. A single finishing device can be used, or the item can be fed (automatically or manually) through a series of different function 3-D finishing devices. As shown in FIG. 3, after the 3-D item 230 is smooth and painted by the 3-D finisher 206, the 3-D item 230 has a more attractive/realistic appearance when compared to the unfinished 3-D item 230 shown in FIG. 2.

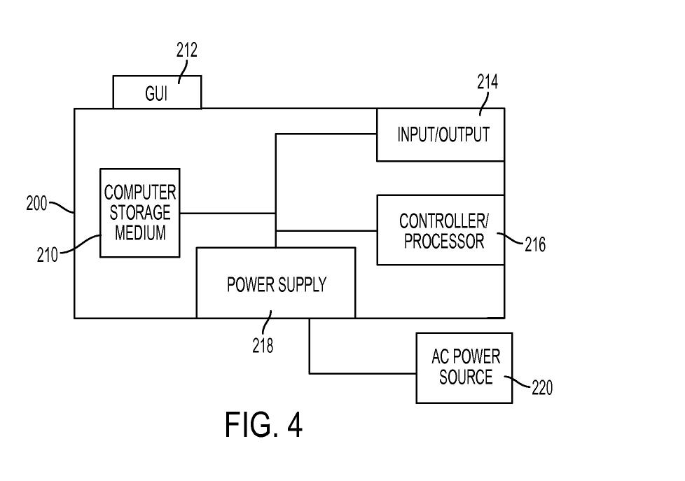

FIG. 4 illustrates a special-purpose communications device 200, which can be used with systems and methods herein. While many potential elements are illustrated in FIG. 4, the special-purpose communications device 200 may contain more elements or less elements, as FIG. 4 illustrates one implementation herein, and claims set forth below are intended to define all possible implementations. For example, the special purpose-communications device 200 can comprise one or more devices, such as stand-alone computers, print servers, or simply custom circuit boards with special-purpose circuitry (such as application specific integrated circuits (ASIC) devices); and such device(s) can be separate devices, or can be integral with the 3-D printer and/or the 3-D finisher device.

In the exemplary implementation shown in FIG. 4, the communications device 200 includes a controller/tangible processor 216 and a communications port (input/output) 214 operatively connected to the tangible processor 216 and to the computerized network 202 external to the communications device 200. Also, the communications device 200 can include at least one accessory functional component, such as a graphical user interface (GUI) assembly 212. The user may receive messages, instructions, and menu options from, and enter instructions through, the graphical user interface or control panel 212. Further, the special-purpose communications device 200 is distinct from the general-purpose computerized device 224 because the special-purpose communications device 200 includes unique logic circuitry (ASICs, etc.), includes unique buffers, communication ports, filters, etc., that are uniquely useful for communication processing, and especially communication processing between 3-D printing devices and 3-D finishing devices.

The input/output device 214 is used for communications to and from the communications device 200 and comprises a wired device or wireless device (of any form, whether currently known or developed in the future). The tangible processor 216 controls the various actions of the computerized device 200. A non-transitory, tangible, computer storage medium device 210 (which can be optical, magnetic, capacitor based, etc., and is different from a transitory signal) is readable by the tangible processor 216 and stores instructions that the tangible processor 216 executes to allow the computerized device 200 to perform its various functions, such as those described herein. Thus, as shown in FIG. 4, a body housing has one or more functional components that operate on power supplied from an alternating current (AC) source 220 by the power supply 218. The power supply 218 can comprise a common power conversion unit, power storage element (e.g., a battery, etc), etc.

Therefore, as shown in FIGS. 1-4, exemplary systems herein include, among other components a three-dimensional (3-D) printer 204 creating 3-D items 230 based on 3-D printing information, and a finishing device 206 operatively (meaning directly or indirectly) connected to the 3-D printer 204. The finishing device 206 performs finishing operations on the 3-D item 230 based on finishing information.

Also, such systems include one or more of the communications devices 200, and such is operatively connected to the 3-D printer 204 and the 3-D finishing device. The communications device 200 can comprise one or more devices, and such device(s) can be separate, stand-alone devices, or the communication device(s) 200 can be integral with the 3-D printer 204 and/or the finisher device 206. The computerized device 224 or the communications device 200 automatically provides the 3-D printing information to the 3-D printer 204, and the 3-D printer 204 or the communications device 200 automatically provides the finishing information to the finishing device; and the communications device 200 provides two-way status information updates between the 3-D printer 204 and the finishing device 206.

For example, the finishing information can comprise command signals and status signals. The status signals can be status information of the progress of the process of creating the 3-D item 230. The command signals can be instructions of finishing operations to be performed on the 3-D item 230. The computerized device 224 and/or communications device 200 can transmit the basic printing instructions and finishing instructions regarding what printing and finishing operations are to be performed, while only the communications device 200 allows the two-way status communication between the 3-D printer 204 and the one or more finishing devices 206. However, in one example that is used herein, the user is allowed to establish all printing and finishing instructions using the computerized device 224 (as a single job), and such a single job is sent only to the 3-D printer 204. After the 3-D printer receives such a single job, it can communicate aspects of the single job to the communications device 200, which then automatically calculates details of what finishing operations are available for the 3-D item produced by the single job, which finisher devices 206 will be used, when the finisher devices 206 should be powered-up or cycled-up, which automated transport equipment should be activated to automatically move the 3-D printed item to different finisher devices 206, etc.

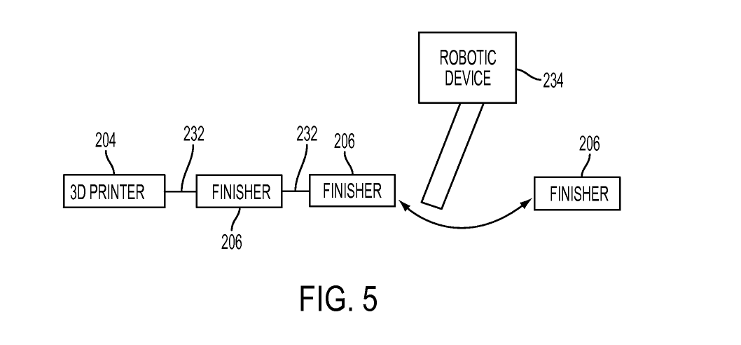

Thus, as shown in FIG. 5, under command of the communications device 200, the 3-D printer 204 can automatically output the 3-D item 230 onto a conveyor belt 232 that automatically supplies the 3-D item 230 to one of the finisher devices 206 according to instructions contained in the single job. Finisher devices 206 can similarly (under command of the communications device 200 following instructions in the single job) automatically output the partially finished 3-D item to other finishers 206 using a conveyor 232 according to instructions contained in the single job. Also, item 234 represents a robotic device, such as a robotic arm that can also automatically (under command of the communications device 200 following instructions in the single job) move the 3-D item 230 created by the 3-D printer 204 to different finisher devices. This allows the user to create the single job and supply the same to only the 3-D printer, after which the systems herein automate all printing, movement, and finishing processes to output the finished 3-D item.

With systems herein, the user merely picks a specific finish (texture, color, etc.) for their 3-D design to include in the single job, and the communications device 200 automatically decides which finisher device(s) to utilize to achieve the selected finish (or a finish that is as close to the selected finish as possible with the finishing equipment that is available), calculates the order that the 3-D item 230 will be supplied to the different 3-D finishing devices 206, and calculates automated movement of the 3-D item 230 between the 3-D printer 204 and the finisher devices 206 that will obtain such a selected finish. Therefore, after the user sends the single job from the CAD program to the 3-D printer 204 and/or the communications device 200, the systems and methods herein calculate which devices are to be used, the order in which they shall be used, and automate all printing, transportation, and finishing processes to fully create and finish the 3-D item 230 without further user input or handling.

Further, by the communications device 200 providing two-way communications between the 3-D printer 204 and the finishers 206, the finishers are only cycled-up to a full power state when they will be used (thereby saving power by preventing unnecessary idling of finisher devices 206 at ready or full power states). Additionally, only finisher devices 206 that have the current capability to perform the finishing operations are chosen by the communications device 200 (e.g., only those finishing devices 206 that have sufficient consumables, do not have failure indicators, are not being utilized for other jobs, etc., are chosen by the communications device 200) to ensure timely completion of all jobs.

In detail, the communications device 200 transmits the finishing information from the 3-D printer 204 to the finishing device 206 at any time after the printing/finishing instructions are received, such as during the time period between when the 3-D printer 204 receives the job (or begins creating the 3-D item 230) and when the 3-D printer 204 completes creating the 3-D item 230. In some limited examples, the finishing information can include the dimensions of the 3-D item 230, instructions to begin cycle-up processes of one or more finishing devices, requests for progress status of finishing operations, requests for ready state, consumable supply levels, and failure status states of the one or more finishing devices, etc.

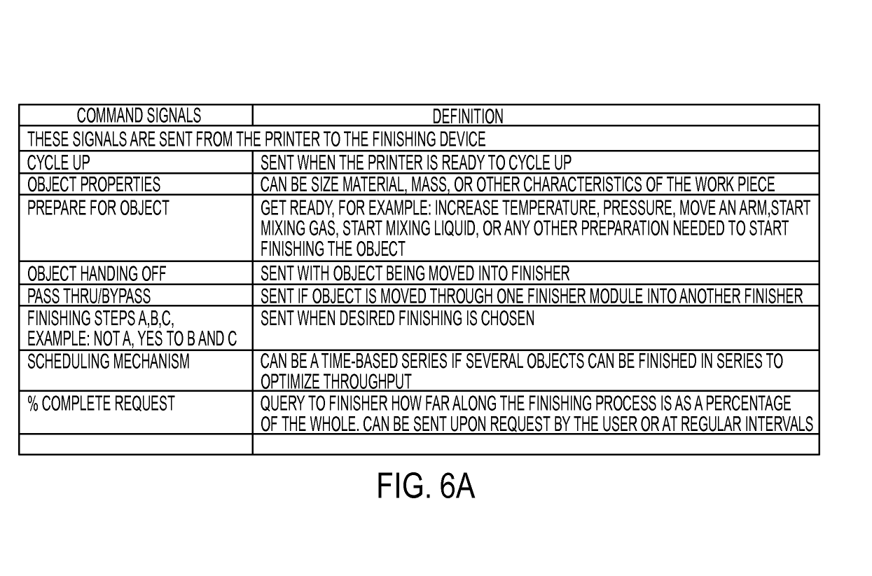

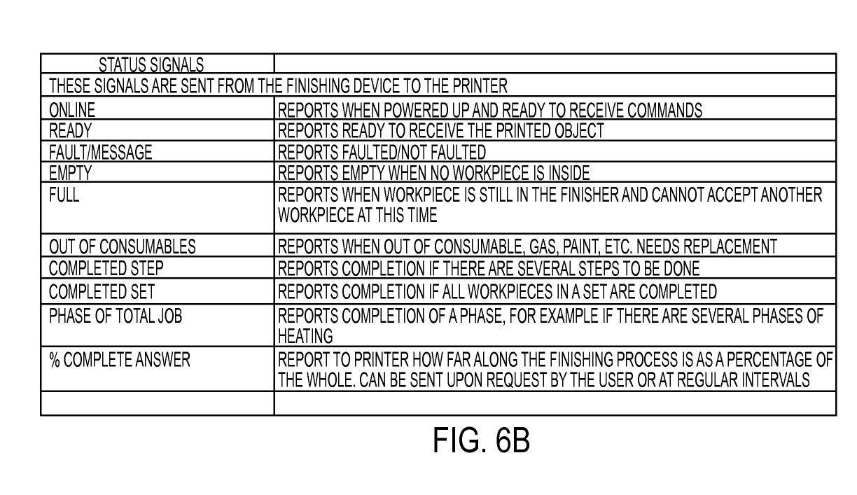

FIGS. 6A and 6B are exemplary command and signal tables used by systems and methods herein. More specifically, the command signals in the top half of FIG. 6A illustrates signals that can be sent from the printer to the finishing device. The cycle up command signal is sent when the printer is ready to cycle up. The object properties command signal can include size material, mass, or other characteristics of the work piece. The prepare for object command signal directs the finisher to get ready, for example: increase temperature, pressure, move an arm, start mixing gas, start mixing liquid, or any other preparation needed to start finishing the object. The object handing off command signal is sent after the object has been moved into finisher. The pass thru/bypass command signal is sent if the object is moved through one finisher module into another finisher. The finishing steps a, b, c, example: not a, yes to b, and c command signal is sent when desired finishing operations are chosen. The scheduling mechanism command signal can be a time-based series, if several objects can be finished in series to optimize throughput. The % complete request command signal provides a query to the finisher as to how far along the finishing process is, as a percentage of the whole. The % complete request command signal can be sent upon request by the user or at regular intervals.

The lower half of FIG. 6B illustrates status signals that can be sent from the finishing device to the printer. The online status signal reports when the finisher is powered up and ready to receive commands. The ready status signal reports that the finisher is ready to receive the printed object. The fault/message status signal reports whether the finisher is faulted or not faulted. The empty status signal reports empty when no workpiece is inside the finisher. The full status signal reports when the workpiece is still in the finisher, and that the finisher cannot accept another workpiece at that time. The out of consumables signal reports when consumable gas, paint, etc., need replacement. The completed step status signal reports completion, if there are several steps to be done. The completed set status signal reports completion, if all workpieces in a set are complete. The phase of total job status signal reports completion of a phase, for example, if there are several phases of heating. The % complete answer signal reports to the printer how far along the finishing process are, as a percentage of the whole. The % complete answer signal can be sent upon request by the user or at regular intervals.

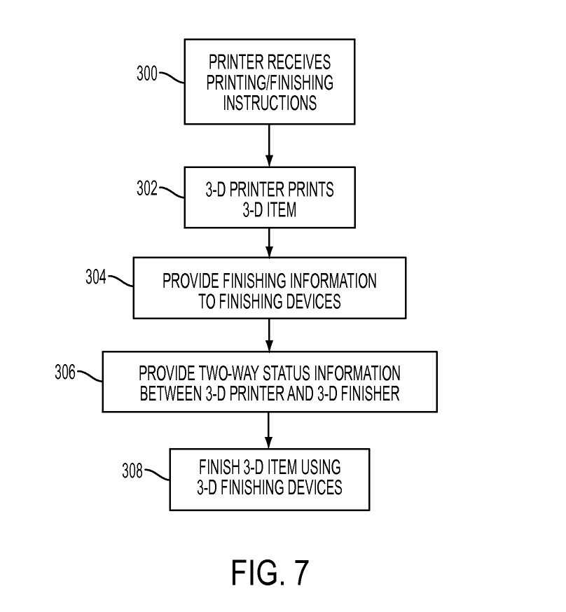

FIG. 7 is a flowchart illustrating exemplary methods herein. In item 300, the three-dimensional (3-D) printer (or the special-purpose communications device) receives the 3-D printing information. More specifically, the methods herein can work with many different system configurations. In one, the method can receive the 3-D print job into the 3-D printer, which forwards the print job to the special purpose communications device, in item 300. In other, the method can receive the 3-D print job first into the special-purpose communication device, which interprets the print job, and determines which instructions are appropriate for the 3-D printer, and which are appropriate for the 3-D finishing devices, in item 300. Thus, in item 300 the 3-D printer or the special purpose communications device can be the first to receive the 3-D print job (which can contain both the printing and finishing instructions) and each device can forward such job to the other device. In another alternative, in item 300, only the printing instructions can be forwarded to the 3-D printing device, and only the finishing instructions can be forwarded to the 3-D finishing device. However, as discussed below, in all such configurations, the communications device automatically provides two-way status updates and instructions between the 3-D printer and the various 3-D finishing devices to optimize the operations of all such devices.

In item 302, the 3-D printer automatically creates the 3-D item based on the 3-D printing information. These methods also automatically provide finishing information to a finishing device using the special-purpose communications device in item 304. Again, the finishing information comprises command signals and status signals, the status signals comprise status information of the progress of the process of creating the 3-D item, the command signals comprise instructions of finishing operations to be performed on the 3-D item, etc. The process of transmitting the finishing information in item 304 transmits the finishing information from the 3-D printer to the finishing device at any time after the printing/finishing instructions are received, such as during the time period between when the 3-D printer begins creating the 3-D item and when the 3-D printer completes creating the 3-D item.

Further, such methods automatically provide two-way status information updates between the 3-D printer and the finishing device using the special-purpose communications device in item 306. The finishing device automatically performs finishing operations on the 3-D item based on the finishing information in item 308. As would be understood by those ordinarily skilled in the art, items 302-306 could be performed in any order, or could be performed in parallel (at the same time) and FIG. 7 is not intended to illustrate the order of steps 302-306.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, printers, copiers, scanners and other similar peripheral equipment are available from Xerox Corporation, Norwalk, Conn., USA and the details of such devices are not discussed herein for purposes of brevity and reader focus. Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A system comprising:
a three-dimensional (3-D) printer creating a 3-D item based on 3-D printing information;
a finishing device operatively connected to said 3-D printer performing finishing operations on said 3-D item based on finishing information; and
a communications device operatively connected to said 3-D printer and said finishing device, said communications device automatically providing said 3-D printing information to said 3-D printer and said finishing information to said finishing device.

2. The system according to claim 1, said finishing information comprising command signals and status signals.

3. The system according to claim 2, said status signals comprising status information of a progress of said creating said 3-D item.

4. The system according to claim 2, said command signals comprising instructions of finishing operations to be performed on said 3-D item.

5. The system according to claim 1, said communications device transmitting said finishing information from said 3-D printer to said finishing device during a time period between when said 3-D printer begins creating said 3-D item and when said 3-D printer completes creating said 3-D item.

6. The system according to claim 1, said communications device comprising one or more devices, said one or more devices being integral with at least one of: said 3-D printer; and said finisher device.

7. The system according to claim 1, said finishing information comprising at least one of:
dimensions of said 3-D item;
instructions to begin cycle-up of one or more finishing devices;
requests for progress status of finishing operations; and
requests for ready state, consumable supply levels, and failure status states of said one or more finishing devices.

8. A system comprising:
a three-dimensional (3-D) printer creating a 3-D item based on 3-D printing information;
a finishing device operatively connected to said 3-D printer performing finishing operations on said 3-D item based on finishing information; and
a communications device operatively connected to said 3-D printer and said finishing device, said communications device automatically providing:
said 3-D printing information to said 3-D printer and said finishing information to said finishing device; and
two-way status information updates between said 3-D printer and said finishing device.

9. The system according to claim 8, said finishing information comprising command signals and status signals.

10. The system according to claim 9, said status signals comprising status information of a progress of said creating said 3-D item.

11. The system according to claim 8, said command signals comprising instructions of finishing operations to be performed on said 3-D item.

12. The system according to claim 8, said communications device transmitting said finishing information from said 3-D printer to said finishing device during a time period between when said 3-D printer begins creating said 3-D item and when said 3-D printer completes creating said 3-D item.

13. The system according to claim 8, said communications device comprising one or more devices, said one or more devices being integral with at least one of: said 3-D printer; and said finisher device.

14. The system according to claim 8, said finishing information comprising at least one of:
dimensions of said 3-D item;
instructions to begin cycle-up of one or more finishing devices;
requests for progress status of finishing operations; and
requests for ready state, consumable supply levels, and failure status states of said one or more finishing devices.

15. A method comprising:
providing 3-D printing information to a three-dimensional (3-D) printer, said 3-D printer automatically creating 3-D item based on said 3-D printing information;
automatically providing finishing information to a finishing device using a special-purpose communications device, said finishing device automatically performing finishing operations on said 3-D item based on said finishing information, and said communications device being operatively connected to said 3-D printer and said finishing device; and
automatically providing two-way status information updates between said 3-D printer and said finishing device using said special-purpose communications device.

16. The method according to claim 15, said finishing information comprising command signals and status signals.

17. The method according to claim 16, said status signals comprising status information of a progress of said creating said 3-D item.

18. The method according to claim 16, said command signals comprising instructions of finishing operations to be performed on said 3-D item.

19. The method according to claim 15, said transmitting said finishing information comprising transmitting said finishing information from said 3-D printer to said finishing device during a time period between when said 3-D printer begins creating said 3-D item and when said 3-D printer completes creating said 3-D item.

20. The method according to claim 15, said communications device comprising one or more devices, said one or more devices being integral with at least one of: said 3-D printer; and said finisher device.
